(19) United States
(12) Patent Application Publication
(10) Pub. No.: US 2024/0045400 A1
(43) Pub. Date: Feb. 8, 2024

(54) Model Optimization Method and Apparatus for Additive Manufacturing, and Storage Medium

(71) Applicant: Siemens Aktiengesellschaft, München (DE)

(72) Inventors: Xiu Jia, Maanshan (CN); Qing Qing Zhang, Shanghai (CN); Chang Peng Li, Beijing (CN)

(73) Assignee: Siemens Aktiengesellschaft, München (DE)

(21) Appl. No.: 18/257,030

(22) PCT Filed: Dec. 16, 2020
(86) PCT No.: PCT/CN2020/136897

§ 371 Date: Jun. 12, 2023

(51) Int. Cl. G05B 19/4099; G06T 7/64; G06T 7/00; G06T 7/13; B29C 64/386; B33Y 50/00

(52) U.S. Cl. CPC G05B 19/4099; G06T 7/64; G06T 7/0006; G06T 7/13; B29C 64/386; B33Y 50/00; G06T 2207/30108; G05B 2219/35134

(57) ABSTRACT

A model optimization method for additive manufacturing may include: acquiring an explicit model of a concept design for additive manufacturing; converting the explicit model to an implicit model represented by a signed distance field formed by a shortest distance from each voxel in a working space to a boundary point of the concept design; determining an unfeasible geometric feature for current additive manufacturing and a detection threshold corresponding thereto; subjecting the implicit model to unfeasible geometric feature detection and iterative processing for correction and optimization based on the detection threshold of the determined unfeasible geometric feature, to obtain an optimized implicit model; and converting the optimized implicit model to an optimized explicit model.

### CROSS-REFERENCE TO RELATED APPLICATIONS

This application is a U.S. National Stage Application of International Application No. PCT/CN2020/136897 filed Dec. 16, 2020, which designates the United States of America, the contents of which are hereby incorporated by reference in their entirety.

### TECHNICAL FIELD

The present application relates to the field of industrial processing. Various embodiments of the teachings herein include model optimization methods and/or systems for additive manufacturing.

### BACKGROUND

Additive manufacturing (AM), commonly known as 3D printing, is a manufacturing technology that combines computer aided design, materials processing, and forming technology, in which software and a numerical control system are used to stack various materials (e.g., special-purpose metal materials, non-metal materials and medical bio-materials) layer-by-layer to manufacture physical items by extrusion, sintering, melting, photocuring, spraying, etc., based on a digital model file. Unlike a conventional processing method in which the original material is removed, cut and assembled, AM produces something where previously there was nothing, by building up material from bottom to top. This makes it possible to manufacture complex structural members that were previously impossible to achieve due to the constraints of conventional manufacturing methods.

AM changes not only the product manufacturing method but also the product design method. Currently, topology optimization software is generally used for AM digital model design, being capable of creating concept designs with complex organic geometric structures. AM offers a level of freedom in design that did not exist before, but to successfully implement AM, the design digital model needs to be in line with the manufacturing capability of the specific AM process, in order to avoid printing failure. The concept design generated by topology optimization generally requires further modification and optimization, in order to eliminate geometric features that are not feasible from the point of view of the AM process manufacturing capability, based on specific manufacturing constraints.

Currently, further modification and optimization of the concept design is chiefly performed manually by a designer, with the aid of computer aided design (CAD) software and tools. The concept design obtained from topology optimization software generally has rough surface details, so can be smoothed and reconstructed using CAD software; this process requires the designer to perform fine adjustment operations manually, which might become monotonous and tedious due to design complexity. The designer then evaluates the CAD model, or identifies unfeasible regions with the aid of specific identification software or tools, and then corrects each unfeasible region manually to meet specific manufacturing requirements.

### SUMMARY

As an example, some embodiments include a model optimization method for additive manufacturing, comprising: acquiring an explicit model of a concept design for additive manufacturing, and converting the explicit model to an implicit model; the implicit model being represented by a signed distance field formed by the shortest distance from each voxel in a working space to a boundary point of the concept design; determining an unfeasible geometric feature for current additive manufacturing and a detection threshold corresponding thereto; subjecting the implicit model to unfeasible geometric feature detection and iterative processing for correction and optimization based on the detection threshold of the determined unfeasible geometric feature, to obtain an optimized implicit model; and converting the optimized implicit model to an explicit model, thus obtaining an optimized explicit model.

In some embodiments, subjecting the implicit model to unfeasible geometric feature detection and iterative processing for correction and optimization based on the detection threshold of the determined unfeasible geometric feature, to obtain an optimized implicit model, comprises: subjecting the implicit model to unfeasible geometric feature detection based on the detection threshold of the determined unfeasible geometric feature; upon detecting that no unfeasible geometric feature is present in the implicit model, taking a current implicit model to be an optimized implicit model; upon detecting that an unfeasible geometric feature is present in the implicit model, establishing a Hamilton-Jacobi equation for a signed distance field of a region where the unfeasible geometric feature is located in the implicit model; assigning a value to a velocity field in the equation according to the principle of correcting an unfeasible geometric feature, and solving the equation to obtain a new signed distance field; and using the new signed distance field to replace the original signed distance field of the region, to obtain a new implicit model, and returning to perform the operation of subjecting the implicit model to unfeasible geometric feature detection based on the detection threshold of the determined unfeasible geometric feature.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a detection sequence of the unfeasible geometric features; determining a current unfeasible geometric feature to be detected according to the detection sequence; subjecting the implicit model to detection of the current unfeasible geometric feature based on the detection threshold of the current unfeasible geometric feature; when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; and when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking a current implicit model to be an optimized implicit model.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a weight of each unfeasible geometric feature; subjecting the implicit model to detection of each unfeasible geometric feature based on the detection threshold of each said unfeasible geometric feature; when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; and when no unfeasible geometric feature is present in the implicit model, taking a current implicit model to be an optimized implicit model.

In some embodiments, the determined unfeasible geometric feature comprises: a thin wall or small hole; subjecting the implicit model to unfeasible geometric feature detection based on the detection threshold of the determined unfeasible geometric feature comprises: extracting a geometric framework of the implicit model; subjecting the geometric framework and the implicit model to matrix multiplication and an operation to find an absolute value, to obtain information of the distance from each point on the geometric framework to a geometric boundary of a corresponding region; and comparing the distance information obtained with the set detection threshold, and determining whether a thin wall or small hole region is present according to the comparison result.

In some embodiments, the determined unfeasible geometric feature comprises: a sharp corner or edge; subjecting the implicit model to unfeasible geometric feature detection based on the detection threshold of the determined unfeasible geometric feature comprises: subjecting a signed distance field of the implicit model to a differentiation operation, to obtain a curvature value of each region; and comparing the curvature value with the corresponding detection threshold, and determining whether a sharp corner or edge region is present according to the comparison result.

As another example, some embodiments include a model optimization apparatus for additive manufacturing, comprising: at least one memory (61) and at least one processor (62), wherein: the at least one memory (61) is configured to store a computer program; the at least one processor (62) is configured to call the computer program stored in the at least one memory (61) to make the apparatus perform corresponding operations, the operations comprising: acquiring an explicit model of a concept design for additive manufacturing, and converting the explicit model to an implicit model; the implicit model being represented by a signed distance field formed by the shortest distance from each voxel in a working space to a boundary point of the concept design; determining an unfeasible geometric feature for current additive manufacturing and a detection threshold corresponding thereto; subjecting the implicit model to unfeasible geometric feature detection and iterative processing for correction and optimization based on the detection threshold of the determined unfeasible geometric feature, to obtain an optimized implicit model; and converting the optimized implicit model to an explicit model, thus obtaining an optimized explicit model.

In some embodiments, subjecting the implicit model to unfeasible geometric feature detection and iterative processing for correction and optimization based on the detection threshold of the determined unfeasible geometric feature, to obtain an optimized implicit model, comprises: subjecting the implicit model to unfeasible geometric feature detection based on the detection threshold of the determined unfeasible geometric feature; upon detecting that no unfeasible geometric feature is present in the implicit model, taking a current implicit model to be an optimized implicit model; upon detecting that an unfeasible geometric feature is present in the implicit model, establishing a Hamilton-Jacobi equation for a signed distance field of a region where the unfeasible geometric feature is located in the implicit model; assigning a value to a velocity field in the equation according to the principle of correcting an unfeasible geometric feature, and solving the equation to obtain a new signed distance field; and using the new signed distance field to replace the original signed distance field of the region, to obtain a new implicit model, and returning to perform the operation of subjecting the implicit model to unfeasible geometric feature detection based on the detection threshold of the determined unfeasible geometric feature.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a detection sequence of the unfeasible geometric features; determining a current unfeasible geometric feature to be detected according to the detection sequence; subjecting the implicit model to detection of the current unfeasible geometric feature based on the detection threshold of the current unfeasible geometric feature; when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; and when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking a current implicit model to be an optimized implicit model.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a weight of each unfeasible geometric feature; subjecting the implicit model to detection of each unfeasible geometric feature based on the detection threshold of each said unfeasible geometric feature; when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; and when no unfeasible geometric feature is present in the implicit model, taking a current implicit model to be an optimized implicit model.

In some embodiments, the determined unfeasible geometric feature comprises: a thin wall or small hole; subjecting the implicit model to unfeasible geometric feature detection based on the detection threshold of the determined unfeasible geometric feature comprises: extracting a geometric framework of the implicit model; subjecting the geometric framework and the implicit model to matrix multiplication and an operation to find an absolute value, to obtain information of the distance from each point on the geometric framework to a geometric boundary of a corresponding region; and comparing the distance information obtained with the set detection threshold, and determining whether a thin wall or small hole region is present according to the comparison result.

In some embodiments, the determined unfeasible geometric feature comprises: a sharp corner or edge; subjecting the implicit model to unfeasible geometric feature detection based on the detection threshold of the determined unfeasible geometric feature comprises: subjecting a signed distance field of the implicit model to a differentiation operation, to obtain a curvature value of each region; and comparing the curvature value with the corresponding detection threshold, and determining whether a sharp corner or edge region is present according to the comparison result.

As another example, some embodiments include a model optimization apparatus for additive manufacturing, comprising: an optimization preparation module (410), for acquiring an explicit model of a concept design for additive manufacturing; and determining an unfeasible geometric feature for current additive manufacturing and a detection threshold corresponding thereto; an implicit model reconstruction module (420), for converting the explicit model to an implicit model; the implicit model being represented by a signed distance field formed by the shortest distance from each voxel in a working space to a boundary point of the concept design; a detection and optimization iteration module (430), for subjecting the implicit model to unfeasible geometric feature detection and iterative processing for correction and optimization based on the detection threshold of the determined unfeasible geometric feature, to obtain an optimized implicit model; and an explicit model reconstruction module (440), for converting the optimized implicit model to an explicit model, thus obtaining an optimized explicit model.

As another example, some embodiments include a computer-readable storage medium, having a computer program stored thereon, characterized in that the computer program is executable by a processor and realizes the model optimization method for additive manufacturing as described herein.

### BRIEF DESCRIPTION OF THE DRAWINGS

Various embodiments of the teachings of the present disclosure are described in detail below with reference to the drawings, to give those skilled in the art a clearer understanding of the abovementioned and other features and advantages of the present application. In the drawings:

FIG. 1 is an exemplary flow chart of a model optimization method for AM incorporating teachings of the present disclosure;

FIG. 2 is a schematic method flow chart of using serial execution incorporating teachings of the present disclosure;

FIG. 3 is a schematic method flow chart of using parallel execution incorporating teachings of the present disclosure;

FIG. 4 is an exemplary structural drawing of a model optimization apparatus for AM incorporating teachings of the present disclosure;

FIGS. 5A-5C show structural schematic drawings of a detection and optimization iteration module incorporating teachings of the present disclosure;

FIG. 6 is an exemplary structural drawing of another model optimization apparatus for AM incorporating teachings of the present disclosure;

FIG. 7A is a schematic drawing of an application scenario of wire arc additive manufacturing (WARM) incorporating teachings of the present disclosure;

FIG. 7B is a schematic drawing of three key geometric features subject to manufacturability constraints in WARM incorporating teachings of the present disclosure; and

FIG. 8 is a schematic drawing of a WARM design correction process incorporating teachings of the present disclosure.

The labels used in the drawings are as follows:

| Label | Meaning |
|---|---|
| 101-104, | Steps |
| 201-207, | |
| 301-305 | |
| 410 | Optimization preparation module |
| 420 | Implicit model reconstruction module |
| 430 | Detection and optimization iteration module |
| 431 | First detection module |
| 432 | First correction optimization module |
| 433 | Optimized implicit model determining module |
| 434 | Current feature determining module |
| 435 | Second detection module |
| 436 | Second correction optimization module |
| 437 | Undetected feature determining module |
| 438 | Third detection module |
| 439 | Third correction optimization module |
| 440 | Explicit model reconstruction module |
| 61 | Memory |
| 62 | Processor |
| 63 | Bus |

### DETAILED DESCRIPTION

Various embodiments of the present application include model optimization methods for AM, model optimization apparatus for AM, and/or computer-readable storage media to increase the efficiency and robustness of model optimization, and reduce manpower costs.

For example, some embodiments include a model optimization method for AM comprising: acquiring an explicit model of a concept design for additive manufacturing, and converting the explicit model to an implicit model; the implicit model being represented by a signed distance field formed by the shortest distance from each voxel in a working space to a boundary point of the concept design; determining an unfeasible geometric feature for current additive manufacturing and a detection threshold corresponding thereto; subjecting the implicit model to unfeasible geometric feature detection and iterative processing for correction and optimization based on the detection threshold of the determined unfeasible geometric feature, to obtain an optimized implicit model; converting the optimized implicit model to an explicit model, thus obtaining an optimized explicit model.

In some embodiments, subjecting the implicit model to unfeasible geometric feature detection and iterative processing for correction and optimization based on the detection threshold of the determined unfeasible geometric feature, to obtain an optimized implicit model, comprises: subjecting the implicit model to unfeasible geometric feature detection based on the detection threshold of the determined unfeasible geometric feature; upon detecting that no unfeasible geometric feature is present in the implicit model, taking a current implicit model to be an optimized implicit model; upon detecting that an unfeasible geometric feature is present in the implicit model, establishing a Hamilton-Jacobi equation for a signed distance field of a region where the unfeasible geometric feature is located in the implicit model; assigning a value to a velocity field in the equation according to the principle of correcting an unfeasible geometric feature, and solving the equation to obtain a new signed distance field; using the new signed distance field to replace the original signed distance field of the region, to obtain a new implicit model, and returning to perform the operation of subjecting the implicit model to unfeasible geometric feature detection based on the detection threshold of the determined unfeasible geometric feature.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a detection sequence of the unfeasible geometric features; determining a current unfeasible geometric feature to be detected according to the detection sequence; subjecting the implicit model to detection of the current unfeasible geometric feature based on the detection threshold of the current unfeasible geometric feature; when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking a current implicit model to be an optimized implicit model.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a weight of each unfeasible geometric feature; subjecting the implicit model to detection of each unfeasible geometric feature based on the detection threshold of each said unfeasible geometric feature; when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; when no unfeasible geometric feature is present in the implicit model, taking a current implicit model to be an optimized implicit model.

In some embodiments, the determined unfeasible geometric feature comprises: a thin wall or small hole; subjecting the implicit model to unfeasible geometric feature detection based on the detection threshold of the determined unfeasible geometric feature comprises: extracting a geometric framework of the implicit model; subjecting the geometric framework and the implicit model to matrix multiplication and an operation to find an absolute value, to obtain information of the distance from each point on the geometric framework to a geometric boundary of a corresponding region; comparing the distance information obtained with the set detection threshold, and determining whether a thin wall or small hole region is present according to the comparison result.

In some embodiments, the determined unfeasible geometric feature comprises: a sharp corner or edge; subjecting the implicit model to unfeasible geometric feature detection based on the detection threshold of the determined unfeasible geometric feature comprises: subjecting a signed distance field of the implicit model to a differentiation operation, to obtain a curvature value of each region; comparing the curvature value with the corresponding detection threshold, and determining whether a sharp corner or edge region is present according to the comparison result.

As another example, some embodiments include a model optimization apparatus for additive manufacturing comprising: at least one memory and at least one processor, wherein: the at least one memory is configured to store a computer program; the at least one processor is configured to call the computer program stored in the at least one memory to make the apparatus perform corresponding operations, the operations comprising: acquiring an explicit model of a concept design for additive manufacturing, and converting the explicit model to an implicit model; the implicit model being represented by a signed distance field formed by the shortest distance from each voxel in a working space to a boundary point of the concept design; determining an unfeasible geometric feature for current additive manufacturing and a detection threshold corresponding thereto; subjecting the implicit model to unfeasible geometric feature detection and iterative processing for correction and optimization based on the detection threshold of the determined unfeasible geometric feature, to obtain an optimized implicit model; converting the optimized implicit model to an explicit model, thus obtaining an optimized explicit model.

In some embodiments, subjecting the implicit model to unfeasible geometric feature detection and iterative processing for correction and optimization based on the detection threshold of the determined unfeasible geometric feature, to obtain an optimized implicit model, comprises: subjecting the implicit model to unfeasible geometric feature detection based on the detection threshold of the determined unfeasible geometric feature; upon detecting that no unfeasible geometric feature is present in the implicit model, taking a current implicit model to be an optimized implicit model; upon detecting that an unfeasible geometric feature is present in the implicit model, establishing a Hamilton-Jacobi equation for a signed distance field of a region where the unfeasible geometric feature is located in the implicit model; assigning a value to a velocity field in the equation according to the principle of correcting an unfeasible geometric feature, and solving the equation to obtain a new signed distance field; using the new signed distance field to replace the original signed distance field of the region, to obtain a new implicit model, and returning to perform the operation of subjecting the implicit model to unfeasible geometric feature detection based on the detection threshold of the determined unfeasible geometric feature.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a detection sequence of the unfeasible geometric features; determining a current unfeasible geometric feature to be detected according to the detection sequence; subjecting the implicit model to detection of the current unfeasible geometric feature based on the detection threshold of the current unfeasible geometric feature; when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking a current implicit model to be an optimized implicit model.

In some embodiments, two or more unfeasible geometric features are determined; subjecting the implicit model to unfeasible geometric feature detection and iterative processing for correction and optimization based on the detection threshold of the determined unfeasible geometric feature, to obtain an optimized implicit model, comprises: determining a weight of each unfeasible geometric feature; subjecting the implicit model to detection of each unfeasible geometric feature based on the detection threshold of each said unfeasible geometric feature; when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; when no unfeasible geometric feature is present in the implicit model, taking a current implicit model to be an optimized implicit model.

In some embodiments, the determined unfeasible geometric feature comprises: a thin wall or small hole; subjecting the implicit model to unfeasible geometric feature detection based on the detection threshold of the determined unfeasible geometric feature comprises: extracting a geometric framework of the implicit model; subjecting the geometric framework and the implicit model to matrix multiplication and an operation to find an absolute value, to obtain information of the distance from each point on the geometric framework to a geometric boundary of a corresponding region; comparing the distance information obtained with the set detection threshold, and determining whether a thin wall or small hole region is present according to the comparison result.

In some embodiments, the determined unfeasible geometric feature comprises: a sharp corner or edge; subjecting the implicit model to unfeasible geometric feature detection based on the detection threshold of the determined unfeasible geometric feature comprises: subjecting a signed distance field of the implicit model to a differentiation operation, to obtain a curvature value of each region; comparing the curvature value with the corresponding detection threshold, and determining whether a sharp corner or edge region is present according to the comparison result.

As another example, some embodiments include a model optimization apparatus for additive manufacturing comprising: an optimization preparation module, for acquiring an explicit model of a concept design for additive manufacturing; and determining an unfeasible geometric feature for current additive manufacturing and a detection threshold corresponding thereto; an implicit model reconstruction module, for converting the explicit model to an implicit model; the implicit model being represented by a signed distance field formed by the shortest distance from each voxel in a working space to a boundary point of the concept design; a detection and optimization iteration module, for subjecting the implicit model to unfeasible geometric feature detection and iterative processing for correction and optimization based on the detection threshold of the determined unfeasible geometric feature, to obtain an optimized implicit model; an explicit model reconstruction module, for converting the optimized implicit model to an explicit model, thus obtaining an optimized explicit model.

As another example, some embodiments include a computer-readable storage medium with a computer program stored thereon; the computer program is executable by a processor and realizes the model optimization method for additive manufacturing as described in any of the embodiments above.

In general, an explicit model of a concept design is converted to an implicit model, and automated detection of unfeasible geometric features and iterative processing for correction and optimization are performed based on the implicit model, finally obtaining an optimized implicit model which is then converted to an explicit model; thus, automated optimization of the concept design is accomplished, the efficiency and robustness of model optimization are increased, and manpower costs are reduced.

In some embodiments, existing solutions perform operations on explicit models of concept designs directly, such as spline-based models and surface/voxel models, which increases the number of times that details are modified in the process. Because a large amount of manual work is involved, the accuracy and efficiency of the modification and optimization process relies to a very high degree on the designer's experience, so robustness is lacking. For this reason, consideration is given in embodiments of the present application to providing automated modification/optimization; for this purpose, an explicit model of a concept design may be converted to an implicit model represented by a signed distance field, and the implicit model then undergoes geometric feature analysis based on mathematical operations and elimination of unfeasible regions, to increase its accuracy, efficiency and robustness.

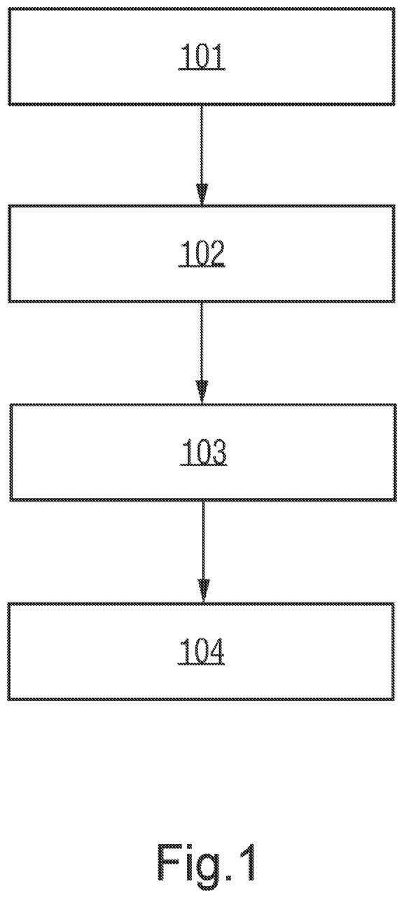

To clarify the objective, technical solution, and advantages of teachings of the present disclosure, the present application is explained in further detail below with examples. FIG. 1 is a flow chart of an example model optimization method for AM incorporating teachings of the present disclosure. As shown in FIG. 1, the method may comprise the following operations.

Step 101 includes acquiring an explicit model of a concept design for AM, and converting the explicit model to an implicit model. Here, the implicit model is defined as the shortest distance from each voxel in a working space to a boundary point of the concept design, i.e. a signed distance field (SDF), represented as cp(x,y,z). In the distance field, voxel positions inside the concept design have negative values, voxel positions outside the concept design have positive values, and boundary positions of the concept design have zero values.

In some embodiments, algorithms such as the fast marching method and fast scanning method, as well as the open source software VTK (Visualization Toolkit), etc., may be used to compute the SDF of the concept design. The computed SDF may be stored as a scalar function in matrix form in a working space containing the concept design. Here, the working space is a 3D space of limited range selected around a 3D geometric body corresponding to a given concept design. This working space is subjected to spatial meshing, and the signed distance field is the distance from each unit point/voxel in the space to the nearest boundary, the form of storage being a 3D matrix.

In some embodiments, the explicit model of the concept design that is imported may be an original design of any format, such as .stl, .stp, .pcd, etc.

Step 102 includes determining an unfeasible geometric feature for current AM and a detection threshold corresponding thereto. The requirements for different AMs might be different, for example, it might not be possible to process sharp corners, thin walls and small hole regions in some AMs; in this case, the unfeasible geometric features for the AMs will be sharp corners, thin walls and small holes. In some AMs, it might not be possible to process small holes, sharp corners and edges, in which case the unfeasible geometric features for the AMs will be small holes, sharp corners and edges. And so on. In addition, due to the fact that it is also necessary to perform judgment according to a preset detection threshold when performing detection of an unfeasible geometric feature, in this step it is also necessary to determine a detection threshold corresponding to an unfeasible geometric feature.

The method of determining an unfeasible geometric feature for the current AM and a detection threshold corresponding thereto may be: receiving an unfeasible geometric feature selected by a user for the current AM and a determined detection threshold thereof; or a system automatically acquiring an unfeasible geometric feature corresponding to the current AM and a detection threshold corresponding thereto, according to the type of the current AM and a preset mapping relationship between each AM and an unfeasible geometric feature and a default detection threshold thereof. Further, if the user is not satisfied with the unfeasible geometric feature for the current AM and the detection threshold corresponding thereto which are determined automatically by the system, it is possible to further receive an adjustment made by the user to the unfeasible geometric feature and the detection threshold corresponding thereto.

Step 103 may include, based on the detection threshold of the determined unfeasible geometric feature, subjecting the implicit model to unfeasible geometric feature detection and iterative processing for correction and optimization, to obtain an optimized implicit model. Specifically, when it is detected that there is no unfeasible geometric feature in the implicit model, a current implicit model is taken to be the optimized implicit model; when it is detected that there is an unfeasible geometric feature in the implicit model, a Hamilton-Jacobi equation is established for the SDF of the region where the unfeasible geometric feature in the implicit model is located, as shown in the following formula (1):

$$\frac{\partial φ}{\partial t} - v ( x , y , z ) \vert ∇ φ \vert = 0 \qquad ( 1 )$$

where v(x,y,z) is the velocity field, defining the movement speed of the curved surface of the SDF cp(x,y,z) in the local normal direction thereof (positive v means inward, negative v means outward). Generally, v(x,y,z) is non-zero in an unfeasible region,

$$\frac{\partial φ}{\partial t}$$

and zero outside. ∇φ is the gradient of the SDF φ(x,y,z). is the partial derivative of the SDF φ(x,y,z) with respect to time.

The velocity field in the equation is assigned a value in accordance with the principle of correcting unfeasible geometric features; for example, sharp corners are subjected to rounding correction, thin walls are subjected to shift correction, etc. The equation is solved to obtain a new SDF, which is used to replace the original SDF of the region, to obtain a new implicit model. The method returns to performing the operation of subjecting the implicit model to unfeasible geometric feature detection based on the detection threshold of the determined unfeasible geometric feature, and the subsequent operations, until no unfeasible geometric feature can be detected, and the implicit model in which no unfeasible geometric feature can be detected is taken to be the optimized implicit model.

As can be seen, in this step, the Hamilton-Jacobi equation is solved on a discrete working space and a one-dimensional time grid, and a numerical method such as the finite difference method is used to update the SDF φ(x,y,z) based on a given velocity field v(x,y,z). Here, rational selection of the time increment can ensure the robustness and stability of the abovementioned correction and optimization method, while the correction amount is also controlled. After each incremental correction, the design enters another detection/correction/optimization iteration, until no unfeasible geometric feature can be detected.

When subjecting the implicit model to unfeasible geometric feature detection, the specific detection method might be different for different unfeasible geometric features. For example, for detection of a thin wall or a small hole, the detection method may comprise: extracting a geometric framework of the implicit model, wherein in particular, geometric frameworks may be divided into two types: a geometric framework inside the concept design, and a geometric framework of a hole region in the concept design. Data of the geometric framework is stored in matrix form in the working space containing the concept design, i.e. the geometric framework is stored in a 3D matrix in the working space. The geometric framework and the implicit model are subjected to matrix multiplication and an operation to find an absolute value, to obtain information of the distance from each point on the geometric framework to a geometric boundary of the corresponding region, and the distance information obtained is compared with the set detection threshold; based on the comparison result, a determination is made as to whether a thin wall or small hole region is present. For example, if the distance result obtained is less than the threshold, then it is determined that there is a thin wall or small hole in the region, and if the result obtained is greater than the threshold, then it is determined that there is no thin wall or small hole in the region.

In some embodiments, for detection of a sharp corner or edge, the detection method may comprise: subjecting the SDF of the implicit model to a differentiation operation, to obtain a curvature value of each region, comparing the curvature value with the corresponding detection threshold, and determining whether a sharp corner or edge region is present according to the comparison result.

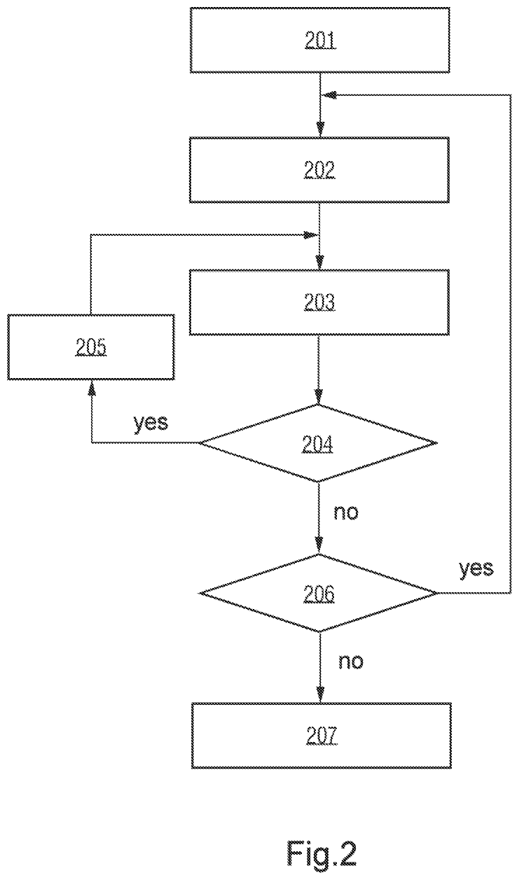

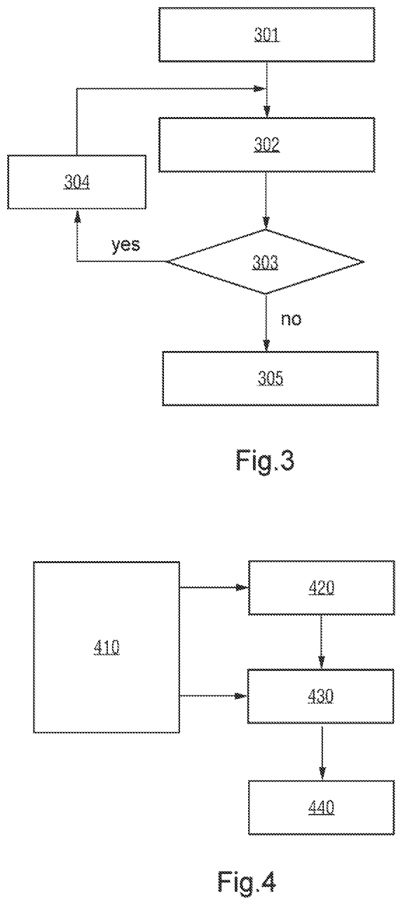

In some embodiments, in the case where multiple unfeasible geometric features are determined in step 102, the specific procedure of this step 103 may be executed in various ways. Examples are serial execution and parallel execution. In some embodiments, the particular manner of execution to be used may also be selected by the user. FIGS. 2 and 3 below describe in detail the two cases of serial execution and parallel execution respectively.

Step 104 may include the optimized implicit model to an explicit model, thus obtaining an optimized explicit model. An isosurface extraction algorithm, such as the marching cube method, etc., may be used to convert the optimized implicit model to an explicit model. The optimized explicit model may be exported in .stl format, or may be further converted to a .stp file, a .pcd file or another type of file, for a subsequent computer aided engineering (CAE), computer aided manufacturing (CAM) or manufacturing process.

FIG. 2 is a flow chart showing a schematic method using serial execution to execute step 103 shown in FIG. 1 incorporating teachings of the present disclosure. As shown in FIG. 2, the method may comprise the following operations.

Step 201 may include determining a detection sequence of unfeasible geometric features during serial execution. A user-inputted detection sequence of unfeasible geometric features may be received; in some embodiments, a detection sequence of unfeasible geometric features during serial execution is determined according to the type of the current AM and a preset mapping relationship between each AM and a default execution sequence of unfeasible geometric features, or according to a preset priority of each unfeasible geometric feature, etc.

Step 202 may include determining a current unfeasible geometric feature to be detected according to the detection sequence.

Step 203 may include, based on the detection threshold of the current unfeasible geometric feature, subjecting the implicit model to detection of the current unfeasible geometric feature.

Step 204 may include judging whether the current unfeasible geometric feature is present in the implicit model, and if so, performing step 205; otherwise, performing step 206.

Step 205 may include establishing a Hamilton-Jacobi equation for the SDF of each region where the current unfeasible geometric feature in the implicit model is located, assigning a value to the velocity field in the equation in accordance with the principle of correcting the current unfeasible geometric feature, solving the equation to obtain a new SDF, using the new SDF to replace the original SDF of the region, to obtain a new implicit model, and returning to step 203.

Step 206 may include judging whether there is still an undetected unfeasible geometric feature, and if so, returning to step 202; otherwise, performing step 207.

Step 207 may include taking the current implicit model to be an optimized implicit model.

FIG. 3 is a schematic flow chart showing an example method of using parallel execution to execute step 103 shown in FIG. 1 in embodiments of the present application. As shown in FIG. 3, the method may comprise the following operations.

Step 301 may include determining a weight of each unfeasible geometric feature during parallel execution. A user-inputted weight of each unfeasible geometric feature may be received; in some embodiments, a weight of each unfeasible geometric feature during parallel execution is determined according to the type of the current AM and a preset mapping relationship between each AM and an unfeasible geometric feature weight.

Step 302 may include, based on the detection threshold of each unfeasible geometric feature, subjecting the implicit model to detection of each said current unfeasible geometric feature.

Step 303 may include judging whether the current unfeasible geometric feature is present in the implicit model, and if so, performing step 304; otherwise, performing step 305.

Step 304 may include establishing a Hamilton-Jacobi equation for the SDF of each region where an unfeasible geometric feature is present in the implicit model, assigning a value to the velocity field in the equation in accordance with the principle of correcting the unfeasible geometric feature, solving the equation to obtain a new SDF, using the new SDF to replace the original SDF of the region, to obtain a new current implicit model, and returning to step 302. When two or more unfeasible geometric features are present in a region of the implicit model, their respective velocity field assigned values are subjected to weighted summation according to the weights of the two or more unfeasible geometric features, as in formula (2) below, to obtain a velocity field overall assigned value for the region, and the velocity field overall assigned value is used to solve the equation to obtain a new SDF.

$$v ( x , y , z ) = {\sum }_{i = 1}^{N} {w}_{i} {v}_{i} ( x , y , z ) \qquad ( 2 )$$

where N is the number of unfeasible geometric features present in the same region; wi is the weight of the ith unfeasible geometric feature, and vᵢ(x,y,z) is the velocity field assigned value of the ith unfeasible geometric feature.

Step 305 may include taking the current implicit model to be an optimized implicit model. The model optimization method for AM has been described in detail above; a model optimization apparatus for AM is described in detail below. The model optimization apparatus for AM described herein may be used to implement the model optimization methods for AM described; for details not disclosed fully in the apparatus embodiments, see the corresponding descriptions in the methods described herein, which are not repeated individually here.

FIG. 4 is a structural drawing of an example model optimization apparatus for AM incorporating teachings of the present disclosure. As shown in FIG. 4, the apparatus may comprise: an optimization preparation module 410, an implicit model reconstruction module 420, a detection and optimization iteration module 430 and an explicit model reconstruction module 440.

The optimization preparation module 410 is configured to acquire an explicit model of a concept design for AM; and determine an unfeasible geometric feature for current AM and a detection threshold corresponding thereto.

The implicit model reconstruction module 420 is configured to convert the explicit model to an implicit model; the implicit model being represented by an SDF formed by the shortest distance from each voxel in a working space to a boundary point of the concept design.

The detection and optimization iteration module 430 is configured to subject the implicit model to unfeasible geometric feature detection and iterative processing for correction and optimization based on the detection threshold of the determined unfeasible geometric feature, to obtain an optimized implicit model.

The explicit model reconstruction module 440 converts the optimized implicit model to an explicit model, thus obtaining an optimized explicit model.

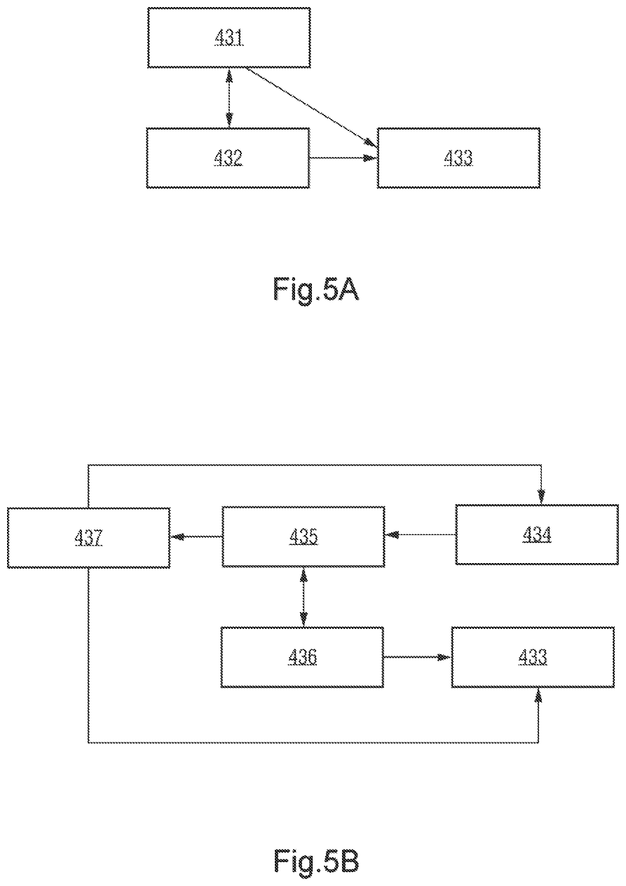

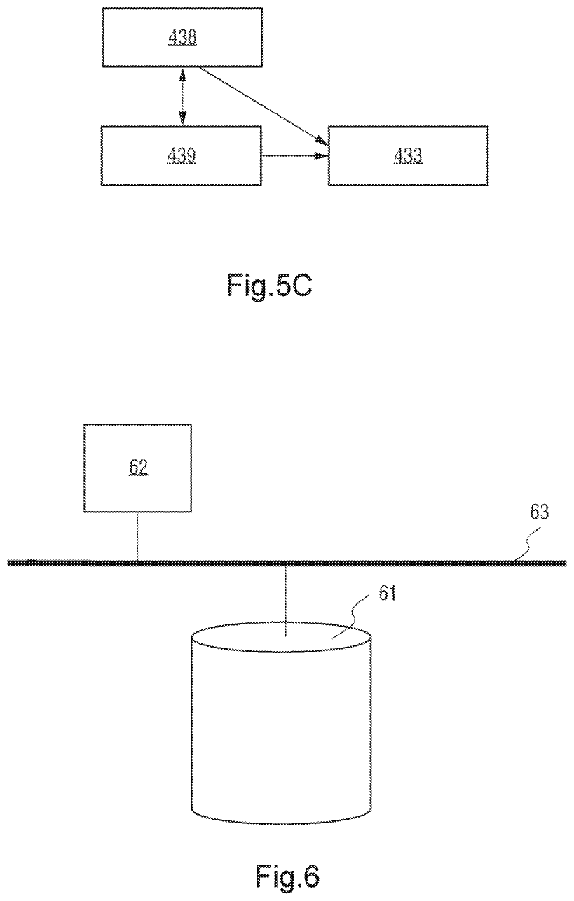

In some embodiments, the detection and optimization iteration module 430 may be implemented in various specific forms; FIGS. 5A-5C show structural schematic drawings of an example detection and optimization iteration module 430 incorporating teachings of the present disclosure.

As shown in FIG. 5A, the detection and optimization iteration module 430 may comprise: a first detection module 431, a first correction optimization module 432 and an optimized implicit model determining module 433.

The first detection module 431 is configured to subject the implicit model to unfeasible geometric feature detection based on the detection threshold of the determined unfeasible geometric feature, and upon detecting that no unfeasible geometric feature is present in the implicit model, send a first instruction to the optimized implicit model determining module 433, the first instruction being used to indicate determination of an optimized implicit model; and upon detecting that an unfeasible geometric feature is present in the implicit model, send a second instruction to the correction optimization module 432, the second instruction being used to indicate a region where the unfeasible geometric feature is located.

The optimized implicit model determining module 433 is configured to take the current implicit model to be an optimized implicit model according to the first instruction.

The first correction optimization module 432 is configured to establish a Hamilton-Jacobi equation for an SDF of the region where the unfeasible geometric feature is located in the implicit model according to the second instruction; assign a value to a velocity field in the equation according to the principle of correcting an unfeasible geometric feature, and solve the equation to obtain a new SDF; use the new SDF to replace the original SDF of the region, to obtain a new implicit model, and provide the new implicit model to the detection module 431 for detection.

In some embodiments, when the optimization preparation module 410 determines two or more unfeasible geometric features, the optimization preparation module 410 may further determine a detection sequence of the unfeasible geometric features. Correspondingly, the detection and optimization iteration module 430 may comprise, as shown in FIG. 5B: a current feature determining module 434, a second detection module 435, a second correction optimization module 436, an undetected feature determining module 437 and an optimized implicit model determining module 433.

The current feature determining module 434 is configured to determine a current unfeasible geometric feature to be detected according to the detection sequence.

The second detection module 435 is configured to subject the implicit model to detection of the current unfeasible geometric feature based on the detection threshold of the current unfeasible geometric feature. When the current unfeasible geometric feature is present in the implicit model, a third instruction is sent to the second correction optimization module 436, the third instruction being used to indicate a region where the current unfeasible geometric feature is located; when it is detected that the current unfeasible geometric feature is not present in the implicit model, a fourth instruction is sent to the undetected feature determining module 437, the fourth instruction being used to indicate judgment of whether there is still an undetected unfeasible geometric feature.

The second correction optimization module 436 is configured to establish a Hamilton-Jacobi equation for an SDF of each region where a current unfeasible geometric feature is located in the implicit model, assign a value to a velocity field in the equation according to the principle of correcting the current unfeasible geometric feature, solve the equation to obtain a new SDF, use the new SDF to replace the original SDF of the region, to obtain a new implicit model, and provide the new implicit model to the second detection module 435 for detection.

The undetected feature determining module 437 is configured to judge whether there is still an undetected unfeasible geometric feature, and if so, send a fifth instruction to the current feature determining module 434, the fifth instruction being used to indicate determination of a current unfeasible geometric feature; otherwise, send a first instruction to the optimized implicit model determining module 433, the first instruction being used to indicate determination of an optimized implicit model.

The optimized implicit model determining module 433 is configured to take the current implicit model to be an optimized implicit model according to the first instruction.

In some embodiments, when the optimization preparation module 410 determines two or more unfeasible geometric features, the optimization preparation module 410 may further determine a weight of each unfeasible geometric feature. Correspondingly, the detection and optimization iteration module 430 may comprise, as shown in FIG. 5C: a third detection module 438, a third correction optimization module 439 and an optimized implicit model determining module 433.

The third detection module 438 is configured to subject the implicit model to detection of each unfeasible geometric feature based on the detection threshold of each said unfeasible geometric feature. When an unfeasible geometric feature is present in the implicit model, a sixth instruction is sent to the third correction optimization module 439, the sixth instruction being used to indicate a region where a current unfeasible geometric feature is located; when it is detected that no unfeasible geometric feature is present in the implicit model, a first instruction is sent to the optimized implicit model determining module 433, the first instruction being used to indicate determination of an optimized implicit model.

The third correction optimization module 439 is configured to establish a Hamilton-Jacobi equation for an SDF of each region where an unfeasible geometric feature is present in the implicit model, assign a value to a velocity field in the equation according to the principle of correcting the unfeasible geometric feature, solve the equation to obtain a new SDF, use the new SDF to replace the original SDF of the region, to obtain a new current implicit model, and provide the new implicit model to the third detection module 438 for detection. When two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new SDF.

The optimized implicit model determining module 433 is configured to take a current implicit model to be an optimized implicit model according to the first instruction.

FIG. 6 is a structural schematic drawing of another example model optimization apparatus for AM incorporating teachings of the present disclosure; the apparatus may be used to implement the methods shown in FIGS. 1-3, or to realize the devices shown in FIGS. 4-5C. As shown in FIG. 6, the system may comprise: at least one memory 61 and at least one processor 62. In addition, it may further comprise some other components, such as a communication port, etc. These components communicate via a bus 63.

The at least one memory 71 is configured to store a computer program. In some embodiments, the computer program may be understood to comprise the modules of the model optimization apparatus for AM shown in FIGS. 4-5C. In addition, the at least one memory 61 may also store an operating system, etc. Operating systems include but are not limited to: Android operating systems, the Symbian operating system, Windows operating systems, Linux operating systems, etc.

The at least one processor 62 is configured to call the computer program stored in the at least one memory 61, to perform the supporting force determining method in embodiments of the present application. Specifically, the at least one processor 62 is configured to call the computer program stored in the at least one memory 61 to make the apparatus perform corresponding operations. The operations may comprise: acquiring an explicit model of a concept design for AM, and converting the explicit model to an implicit model; the implicit model being represented by an SDF formed by the shortest distance from each voxel in a working space to a boundary point of a concept design; determining an unfeasible geometric feature for current AM and a detection threshold corresponding thereto; subjecting the implicit model to unfeasible geometric feature detection and iterative processing for correction and optimization based on the detection threshold of the determined unfeasible geometric feature, to obtain an optimized implicit model; converting the optimized implicit model to an explicit model, thus obtaining an optimized explicit model.

In some embodiments, the operation of subjecting the implicit model to unfeasible geometric feature detection and iterative processing for correction and optimization based on the detection threshold of the determined unfeasible geometric feature, to obtain an optimized implicit model, comprises: subjecting the implicit model to unfeasible geometric feature detection based on the detection threshold of the determined unfeasible geometric feature; upon detecting that no unfeasible geometric feature is present in the implicit model, taking a current implicit model to be an optimized implicit model; upon detecting that an unfeasible geometric feature is present in the implicit model, establishing a Hamilton-Jacobi equation for an SDF of the region where the unfeasible geometric feature is located in the implicit model; assigning a value to a velocity field in the equation according to the principle of correcting an unfeasible geometric feature, and solving the equation to obtain a new SDF; using the new SDF to replace the original SDF of the region, to obtain a new implicit model, and returning to perform the operation of subjecting the implicit model to unfeasible geometric feature detection based on the detection threshold of the determined unfeasible geometric feature.

In some embodiments, two or more unfeasible geometric features are determined; and the operation of subjecting the implicit model to unfeasible geometric feature detection and iterative processing for correction and optimization based on the detection threshold of the determined unfeasible geometric feature, to obtain an optimized implicit model, comprises: determining a detection sequence of the unfeasible geometric features; determining a current unfeasible geometric feature to be detected according to the detection sequence; subjecting the implicit model to detection of the current unfeasible geometric feature based on the detection threshold of the current unfeasible geometric feature; when the current unfeasible geometric feature is present in the implicit model, establishing a Hamilton-Jacobi equation for an SDF of each region where a current unfeasible geometric feature is located in the implicit model, assigning a value to a velocity field in the equation according to the principle of correcting the current unfeasible geometric feature, solving the equation to obtain a new SDF, using the new SDF to replace the original SDF of the region, to obtain a new implicit model, and returning to perform the operation of subjecting the implicit model to detection of the current unfeasible geometric feature based on the detection threshold of the current unfeasible geometric feature; when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking the current implicit model to be an optimized implicit model.

In some embodiments, two or more unfeasible geometric features are determined; and the operation of subjecting the implicit model to unfeasible geometric feature detection and iterative processing for correction and optimization based on the detection threshold of the determined unfeasible geometric feature, to obtain an optimized implicit model, comprises: determining a weight of each unfeasible geometric feature; subjecting the implicit model to detection of each unfeasible geometric feature based on the detection threshold of each said unfeasible geometric feature; when an unfeasible geometric feature is present in the implicit model, establishing a Hamilton-Jacobi equation for an SDF of each region where an unfeasible geometric feature is present in the implicit model, assigning a value to a velocity field in the equation according to the principle of correcting the unfeasible geometric feature, solving the equation to obtain a new SDF, using the new SDF to replace the original SDF of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new SDF; when no unfeasible geometric feature is present in the implicit model, a current implicit model is taken to be an optimized implicit model.

In some embodiments, the determined unfeasible geometric feature comprises: a thin wall or a small hole; and the operation of subjecting the implicit model to unfeasible geometric feature detection based on the detection threshold of the determined unfeasible geometric feature comprises: extracting a geometric framework of the implicit model; subjecting the geometric framework and the implicit model to matrix multiplication and an operation to find an absolute value, to obtain information of the distance from each point on the geometric framework to a geometric boundary of the corresponding region; comparing the distance information obtained with a set detection threshold, and determining whether a thin wall or small hole region is present according to the comparison result.

In some embodiments, the determined unfeasible geometric feature comprises: a sharp corner or edge; and the operation of subjecting the implicit model to unfeasible geometric feature detection based on the detection threshold of the determined unfeasible geometric feature comprises: subjecting an SDF of the implicit model to a differentiation operation, to obtain a curvature value of each region; comparing the curvature value with the corresponding detection threshold, and determining whether a sharp corner or edge region is present according to the comparison result.

The processor 62 may be a CPU, processing unit/module, ASIC, logic module or programmable gate array, etc. It can receive and send data via the communication port.

In some embodiments, not all of the steps and modules in the above procedures and structural drawings are necessary; certain steps or modules may be omitted according to actual needs. The order in which the steps are performed is not fixed, and may be adjusted as needed. The division of modules is merely functional division adopted to facilitate description; in practice, one module may be realized by multiple modules, and the functions of multiple modules may be realized by the same module, and these modules may be located in the same device or different devices.

It will be understood that hardware modules in the embodiments above may be realized mechanically or electronically. For example, a hardware module may include a specially designed permanent circuit or logic device (such as a dedicated processor, such as an FPGA or ASIC) for performing specific operations. A hardware module may also include a programmable logic device or circuit configured temporarily by software (e.g. including a general-purpose processor or another programmable processor) for performing specific operations. The decision to specifically use a mechanical method or a dedicated permanent circuit or a temporarily configured circuit (e.g. configured by software) to realize a hardware module may be made on the basis of cost and time considerations.

In some embodiments, a computer-readable storage medium having a computer program stored thereon is executable by a processor and realizes the model optimization method for AM as described in embodiments of the present application. Specifically, a system or apparatus equipped with a storage medium, wherein software program code realizing the functions of any one of the above embodiments is stored on the storage medium, and a computer (or CPU or MPU) of the system or apparatus is caused to read and execute the program code stored in the storage medium. In addition, an operating system operating on a computer, etc. may be made to complete some or all of the actual operations by means of instructions based on program code. Program code read out from the storage medium may also be written into a memory installed in an expansion board inserted in the computer, or written into a memory installed in an expansion unit connected to the computer, and thereafter instructions based on the program code make a CPU etc. installed on the expansion board or expansion unit execute some or all of the actual operations, so as to realize the functions of any of the embodiments above. Embodiments of storage media used to provide program code include floppy disks, hard disks, magneto-optical disks, optical disks (e.g. CD-ROM, CD-R, CD-RW, DVD-ROM, DVD-RAM, DVD-RW, DVD+RW), magnetic tape, non-volatile memory cards and ROM. Optionally, program code may be downloaded from a server computer over a communication network.

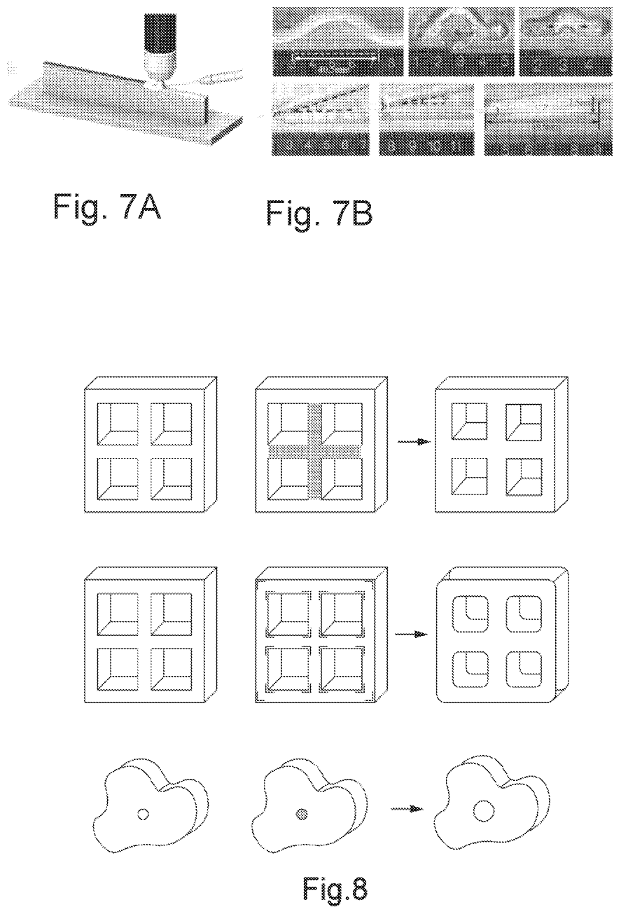

The technical solution in the present application is explained through the example of a particular AM application scenario. FIG. 7A is an application scenario of wire arc additive manufacturing (WARM) in an example of the present application; WARM is a variant of directed energy deposition (DED) technology, using an arc welding process to print metal parts. Regarding the WARM process, three determined key geometric features subject to manufacturability constraints are shown in FIG. 7B, specifically: the smallest member dimension (limited by wheel span), the smallest hole diameter corresponding to the circle diameter marked at the top right corner of FIG. 7, and the largest local sharpness corresponding to the angle marked at the lower right of FIG. 7 (corresponding to corner/edge sharpness).

Regarding these three key geometric features, two conventional correction operations may be enabled: shift (used for thin members and tiny internal cavities) and rounding (used for sharp corners and edges). When no unfeasible region is detected in the design, the iterative detection and correction steps end.

FIG. 8 shows a schematic drawing of an example WARM design correction process incorporating teachings of the present disclosure. As shown in FIG. 8, for the cross structure at the left side, shift and rounding operations are performed to increase member thickness and eliminate sharp inner and outer edges. For the design at the left side with the tiny round hole, a shift operation is used to expand the model cavity, in order to satisfy the smallest dimension constraint of the internal cavity.

In some embodiments, an explicit model of a concept design is converted to an implicit model, and automated detection of unfeasible geometric features and iterative processing for correction and optimization are performed based on the implicit model, finally obtaining an optimized implicit model which is then converted to an explicit model; thus, automated optimization of the concept design is accomplished, the efficiency and robustness of model optimization are increased, and manpower costs are reduced.

The above are merely example embodiments of the present application, which are not intended to limit it. Any modifications, equivalent substitutions or improvements, etc. made within the spirit and principles of the present application should be included in the scope of protection thereof.

What is claimed is:

1. A model optimization method for additive manufacturing, the method comprising:
acquiring an explicit model of a concept design for additive manufacturing;
converting the explicit model to an implicit model represented by a signed distance field formed by a shortest distance from each voxel in a working space to a boundary point of the concept design;
determining an unfeasible geometric feature for current additive manufacturing and a detection threshold corresponding thereto;
subjecting the implicit model to unfeasible geometric feature detection and iterative processing for correction and optimization based on the detection threshold of the determined unfeasible geometric feature, to obtain an optimized implicit model; and
converting the optimized implicit model to an optimized explicit model.

2. The model optimization method for additive manufacturing as claimed in claim 1, wherein subjecting the implicit model to unfeasible geometric feature detection and iterative processing for correction and optimization based on the detection threshold of the determined unfeasible geometric feature to obtain an optimized implicit model comprises:
subjecting the implicit model to unfeasible geometric feature detection based on the detection threshold of the determined unfeasible geometric feature;
upon detecting that no unfeasible geometric feature is present in the implicit model, taking a current implicit model to be an optimized implicit model;
upon detecting that an unfeasible geometric feature is present in the implicit model, establishing a Hamilton-Jacobi equation for a signed distance field of a region where the unfeasible geometric feature is located in the implicit model;
assigning a value to a velocity field in the equation according to the principle of correcting an unfeasible geometric feature, and solving the equation to obtain a new signed distance field; and
using the new signed distance field to replace the original signed distance field of the region to obtain a new implicit model, and returning to perform the operation of subjecting the implicit model to unfeasible geometric feature detection based on the detection threshold of the determined unfeasible geometric feature.

3. The model optimization method for additive manufacturing as claimed in claim 1, wherein two or more unfeasible geometric features are determined;
subjecting the implicit model to unfeasible geometric feature detection and iterative processing for correction and optimization based on the detection threshold of the determined unfeasible geometric feature to obtain an optimized implicit model comprises:
determining a detection sequence of the unfeasible geometric features;
determining a current unfeasible geometric feature to be detected according to the detection sequence;
subjecting the implicit model to detection of the current unfeasible geometric feature based on the detection threshold of the current unfeasible geometric feature;
when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; and
when the current unfeasible geometric feature is not present in the implicit model, judging whether there is still an undetected unfeasible geometric feature, and if so, returning to perform the operation of determining a current unfeasible geometric feature to be detected according to the detection sequence;
otherwise, taking a current implicit model to be an optimized implicit model.

4. The model optimization method for additive manufacturing as claimed in claim 1, wherein two or more unfeasible geometric features are determined;
subjecting the implicit model to unfeasible geometric feature detection and iterative processing for correction and optimization based on the detection threshold of the determined unfeasible geometric feature T to obtain an optimized implicit model comprises:
determining a weight of each unfeasible geometric feature;
subjecting the implicit model to detection of each unfeasible geometric feature based on the detection threshold of each said unfeasible geometric feature;
when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; and
when no unfeasible geometric feature is present in the implicit model, taking a current implicit model to be an optimized implicit model.

5. The model optimization method for additive manufacturing as claimed in claim 1, wherein the determined unfeasible geometric feature comprises a thin wall or small hole; and
subjecting the implicit model to unfeasible geometric feature detection based on the detection threshold of the determined unfeasible geometric feature comprises:
extracting a geometric framework of the implicit model;
subjecting the geometric framework and the implicit model to matrix multiplication and an operation to find an absolute value, to obtain information of the distance from each point on the geometric framework to a geometric boundary of a corresponding region; and
comparing the distance information obtained with the set detection threshold, and determining whether a thin wall or small hole region is present according to the comparison result.

6. The model optimization method for additive manufacturing as claimed in claim 1, wherein the determined unfeasible geometric feature comprises a sharp corner or edge;
subjecting the implicit model to unfeasible geometric feature detection based on the detection threshold of the determined unfeasible geometric feature comprises:
subjecting a signed distance field of the implicit model to a differentiation operation, to obtain a curvature value of each region;
comparing the curvature value with the corresponding detection threshold and determining whether a sharp corner or edge region is present according to the comparison result.

7. A model optimization apparatus for additive manufacturing, the apparatus comprising:
at least one memory; and
at least one processor;
wherein
the at least one memory stores a computer program;
the at least one processor is configured to call the computer program stored in the at least one memory to make the apparatus perform corresponding operations, the operations comprising:
acquiring an explicit model of a concept design for additive manufacturing, and converting the explicit model to an implicit model; the implicit model being represented by a signed distance field formed by the shortest distance from each voxel in a working space to a boundary point of the concept design;
determining an unfeasible geometric feature for current additive manufacturing and a detection threshold corresponding thereto;
subjecting the implicit model to unfeasible geometric feature detection and iterative processing for correction and optimization based on the detection threshold of the determined unfeasible geometric feature, to obtain an optimized implicit model; and
converting the optimized implicit model to an explicit model, thus obtaining an optimized explicit model.

8. The model optimization apparatus for additive manufacturing as claimed in claim 7, wherein subjecting the implicit model to unfeasible geometric feature detection and iterative processing for correction and optimization based on the detection threshold of the determined unfeasible geometric feature to obtain an optimized implicit model comprises:
subjecting the implicit model to unfeasible geometric feature detection based on the detection threshold of the determined unfeasible geometric feature;
upon detecting that no unfeasible geometric feature is present in the implicit model, taking a current implicit model to be an optimized implicit model;
upon detecting that an unfeasible geometric feature is present in the implicit model, establishing a Hamilton-Jacobi equation for a signed distance field of a region where the unfeasible geometric feature is located in the implicit model;
assigning a value to a velocity field in the equation according to the principle of correcting an unfeasible geometric feature, and solving the equation to obtain a new signed distance field; and
using the new signed distance field to replace the original signed distance field of the region, to obtain a new implicit model, and returning to perform the operation of subjecting the implicit model to unfeasible geometric feature detection based on the detection threshold of the determined unfeasible geometric feature.

9. The model optimization apparatus for additive manufacturing as claimed in claim 7, wherein two or more unfeasible geometric features are determined;
subjecting the implicit model to unfeasible geometric feature detection and iterative processing for correction and optimization based on the detection threshold of the determined unfeasible geometric feature, to obtain an optimized implicit model, comprises:
determining a detection sequence of the unfeasible geometric features;
determining a current unfeasible geometric feature to be detected according to the detection sequence;
subjecting the implicit model to detection of the current unfeasible geometric feature based on the detection threshold of the current unfeasible geometric feature;
when the current unfeasible geometric feature is present in the implicit model, establishing a Hamilton-Jacobi equation for a signed distance field of each region where the current unfeasible geometric feature is located in the implicit model, and assigning a value to a velocity field in the equation according to the principle of correcting the current unfeasible geometric feature, solving the equation to obtain a new signed distance field, using the new signed distance field to replace the original signed distance field of the region, to obtain a new implicit model, and returning to perform the operation of subjecting the implicit model to detection of the current unfeasible geometric feature based on the detection threshold of the current unfeasible geometric feature; and
when the current unfeasible geometric feature is not present in the implicit model, judging whether there is still an undetected unfeasible geometric feature, and if so, returning to perform the operation of determining a current unfeasible geometric feature to be detected according to the detection sequence; otherwise, taking a current implicit model to be an optimized implicit model.

10. The model optimization apparatus for additive manufacturing as claimed in claim 7, wherein two or more unfeasible geometric features are determined;
subjecting the implicit model to unfeasible geometric feature detection and iterative processing for correction and optimization based on the detection threshold of the determined unfeasible geometric feature, to obtain an optimized implicit model, comprises:
determining a weight of each unfeasible geometric feature;
subjecting the implicit model to detection of each unfeasible geometric feature based on the detection threshold of each said unfeasible geometric feature;
when an unfeasible geometric feature is present in the implicit model, establishing a Hamilton-Jacobi equation for a signed distance field of each region where an unfeasible geometric feature is present in the implicit model, and assigning a value to a velocity field in the equation according to the principle of correcting the unfeasible geometric feature, solving the equation to obtain a new signed distance field, using the new signed distance field to replace the original signed distance field of the region, to obtain a new current implicit model, and returning to perform the operation of subjecting the implicit model to detection of each unfeasible geometric feature based on the detection threshold of each said unfeasible geometric feature; wherein, when two or more unfeasible geometric features are present in a region of the implicit model, their respective velocity field assigned values are subjected to weighted summation according to the weights of the two or more unfeasible geometric features, to obtain a velocity field overall assigned value for the region, and the velocity field overall assigned value is used to solve the equation to obtain a new signed distance field; and
when no unfeasible geometric feature is present in the implicit model, taking a current implicit model to be an optimized implicit model.

11. The model optimization apparatus for additive manufacturing as claimed in claim 7, wherein the determined unfeasible geometric feature comprises a thin wall or small hole;
subjecting the implicit model to unfeasible geometric feature detection based on the detection threshold of the determined unfeasible geometric feature comprises:
extracting a geometric framework of the implicit model;
subjecting the geometric framework and the implicit model to matrix multiplication and an operation to find an absolute value, to obtain information of the distance from each point on the geometric framework to a geometric boundary of a corresponding region; and
comparing the distance information obtained with the set detection threshold, and determining whether a thin wall or small hole region is present according to the comparison result.

12. The model optimization apparatus for additive manufacturing as claimed in claim 7, wherein the determined unfeasible geometric feature comprises a sharp corner or edge;
subjecting the implicit model to unfeasible geometric feature detection based on the detection threshold of the determined unfeasible geometric feature comprises:
subjecting a signed distance field of the implicit model to a differentiation operation, to obtain a curvature value of each region; and
comparing the curvature value with the corresponding detection threshold, and determining whether a sharp corner or edge region is present according to the comparison result.

13. A model optimization apparatus for additive manufacturing, the apparatus comprising:
an optimization preparation module for acquiring an explicit model of a concept design for additive manufacturing;-and determining an unfeasible geometric feature for current additive manufacturing and a detection threshold corresponding thereto;
an implicit model reconstruction module, for converting the explicit model to an implicit model represented by a signed distance field formed by the shortest distance from each voxel in a working space to a boundary point of the concept design;
a detection and optimization iteration module for subjecting the implicit model to unfeasible geometric feature detection and iterative processing for correction and optimization based on the detection threshold of the determined unfeasible geometric feature, to obtain an optimized implicit model; and
an explicit model reconstruction module for converting the optimized implicit model to an explicit model, thus obtaining an optimized explicit model.

14. (canceled)
